(19) United States
(12) Patent Application Publication
(10) Pub. No.: US 2021/0158368 A1
(43) Pub. Date: May 27, 2021

(54) METHOD AND SYSTEM FOR GENERATING RESPONSES TO TRANSACTION DISPUTES ASSOCIATED WITH A MERCHANT

(71) Applicant: Midigator, LLC, American Fork, UT (US)

(72) Inventor: Corey J. BAGGETT, St. Thomas, VI (US)

(21) Appl. No.: 16/714,491

(22) Filed: Dec. 13, 2019

Related U.S. Application Data
(60) Provisional application No. 62/940,156, filed on Nov. 25, 2019.

(51) Int. Cl. G06Q 30/00; G06Q 20/40; G06Q 20/42; G06Q 20/38

(52) U.S. Cl. CPC G06Q 30/016; G06Q 20/388; G06Q 20/425; G06Q 20/405

(57) ABSTRACT

A method including determining, from a plurality of payment processing parties, a plurality of payment disputes associated with a merchant, where the plurality of payment processing entities include a first payment processing party and a second payment processing party. The plurality of payment disputes includes a first payment dispute associated with the first payment processing party and a second payment dispute associated with the second payment processing party. The method further includes collecting, from the first payment processing party, first dispute information associated with the first payment dispute and collecting, from the second payment processing party, second dispute information associated with the second payment dispute. The method includes displaying the first dispute information and the second dispute information together on a graphical user interface. The method includes, in response to displaying the first dispute information and second dispute information, receiving, from the merchant, an action to resolve the first payment dispute. The method further includes automatically generating a form response to the first payment dispute in response to receiving the action to resolve the first payment dispute. Finally, the method includes transmitting, to the first payment processing party, the form response to the first payment dispute in response to automatically generating the form response to the first payment dispute.

### CROSS-REFERENCE TO RELATED APPLICATION

This application claims the benefit of U.S. Provisional Patent Application No. 62/940,156 filed on Nov. 25, 2019, the disclosure of which is incorporated herein by reference in its entirety.

### BACKGROUND

This disclosure relates generally to a dispute processing system and method, and more specifically to a system and method for maintaining and responding to payment disputes.

### BRIEF SUMMARY

According to one aspect of the present disclosure, a method includes determining, from a plurality of payment processing parties, a plurality of payment disputes associated with a merchant, where the plurality of payment processing entities include a first payment processing party and a second payment processing party. The plurality of payment disputes includes a first payment dispute associated with the first payment processing party and a second payment dispute associated with the second payment processing party. The method further includes collecting, from the first payment processing party, first dispute information associated with the first payment dispute and collecting, from the second payment processing party, second dispute information associated with the second payment dispute. The method includes displaying the first dispute information and the second dispute information together on a graphical user interface. The method includes, in response to displaying the first dispute information and second dispute information, receiving, from the merchant, an action to resolve the first payment dispute. The method further includes automatically generating a form response to the first payment dispute in response to receiving the action to resolve the first payment dispute. Finally, the method includes transmitting, to the first payment processing party, the form response to the first payment dispute in response to automatically generating the form response to the first payment dispute.

### BRIEF DESCRIPTION OF THE DRAWINGS

Aspects of the present disclosure are illustrated by way of example and are not limited by the accompanying figures with like references indicating like elements.

FIG. 1 illustrates a dispute processing system in a non-limiting embodiment of the present disclosure.

FIG. 2 illustrates the hardware components of a dispute processing system in a non-limiting embodiment of the present disclosure.

FIG. 3 illustrates a flow chart of the method of displaying and responding to payment disputes in a non-limiting embodiment of the present disclosure.

FIG. 4A illustrates the home screen of a graphical user interface in a non-limiting embodiment of the present disclosure.

FIG. 4B illustrates action options of a graphical user interface in a non-limiting embodiment of the present disclosure.

FIG. 5A illustrates a customizable response package in a non-limiting embodiment of the present disclosure.

FIG. 5B illustrates a transaction information section of a customizable response package in a non-limiting embodiment of the present disclosure.

FIG. 5C illustrates a delivery confirmation section of a customizable response package in a non-limiting embodiment of the present disclosure.

FIG. 6 illustrates analytics information displayed on a graphical user interface in a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Processing credit card payment disputes is a complicated and time consuming process, due to the number of potential disputes, and various manners in which particular merchants would like to handle such disputes. It is not uncommon for any particular organization to have dozens, hundreds or even thousands of merchant accounts to manage. For example, many large retailers maintain at least one merchant account per store, or per state or per country. Such organizations do not have the resources to manage such dispute processing systems without assistance from third parties.

When a dispute arises, it is often difficult to match the dispute with a particular transaction(s). To do so, often requires a thorough review of all transactions by the organization to determine the transaction that is being disputed. This adds to the resources required to manage such disputes. For at least these reasons, most large organization rely, at least in part, on third parties for assistance.

Tools exist that will allow third parties to automatically determine the likely transaction that is in dispute (see e.g., U.S. patent application Ser. No. 14/292,496, entitled Transaction Matching and filed May 30, 2014, which is hereby incorporated by reference), by automatically analyzing all transactions of the organization. Tools also exist for retrieving transactions and for generating alerts (See e.g., U.S. patent application Ser. No. 14/292,471, entitled Transaction Retrieval and filed May 30, 2014 and U.S. patent application Ser. No. 14/292,513, entitled Alert Generation and filed May 30, 2014, each of which is hereby incorporated by reference).

Often times there will be limited information available regarding the disputed transaction. For example, in order to avoid financial breaches, many organizations will not maintain complete credit card numbers or credit card holder personal information. Thus, armed with limited data (e.g., last four digits of a credit card) and/or a transaction amount in question, it is often difficult to determine which transaction is in dispute.

Another layer of complexity exists regarding organizations that are unable or unwilling to share all transaction data with a third party that is assisting with dispute processing. Large organizations avoid sharing all transaction data with third parties since this information is confidential, and breach or loss of such data can result in liability to the organization. Thus, most organizations prefer to provide as little information as possible about its transactions, to third parties that are helping to process such disputes. This makes it much more difficult for the third parties.

A delicate balance exists between automated systems that are able to crawl through transaction data to identify particular transactions that are in dispute, and limiting the amount of information made available to those automated systems. Thus, it is helpful to provide systems and methods for dispute processing that are partially automated, but allow for an organization relying upon assistance from a third party, to limit the amount of data that the organization provides to the third party.

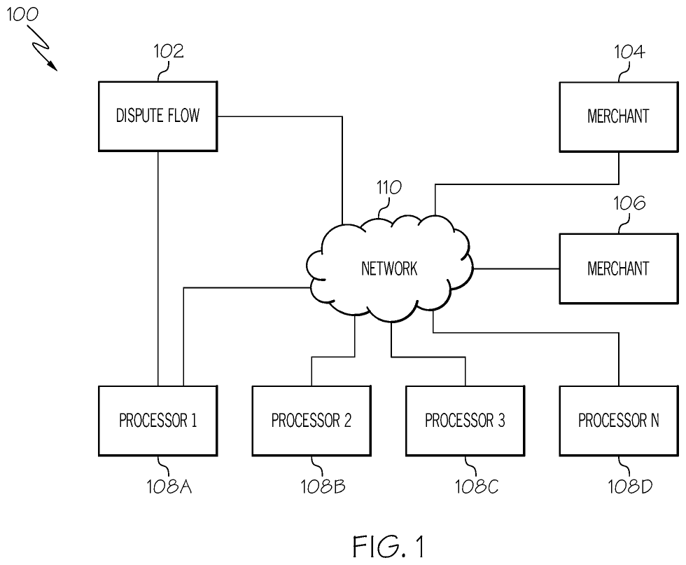

FIG. 1 illustrates a dispute processing system 100 in a non-limiting embodiment of the present disclosure. A dispute processing system 100 may include the DisputeFlow system 102, multiple merchants 104 and 106, multiple payment processing parties 108, and a network 110.

The DisputeFlow system 102 may comprise one or more systems that allow the dispute processing system 100 to operate. The DisputeFlow system 102 may connect to the merchants 104 and 106 using a network (e.g., the internet, a LAN, a WAN, a private network, or other interconnected system). In some embodiments, the DisputeFlow system 102 may also connect to the payment processing parties 108 using the network 110. In some embodiments, the DisputeFlow system 102 may connect to the payment processing parties 108A using a different communication protocol than the merchant's communication protocol. For example, in some embodiments, the DisputeFlow system 102 may communicate directly with the payment processing party 108A using a telephone call, fax, email, API, or other communication protocol.

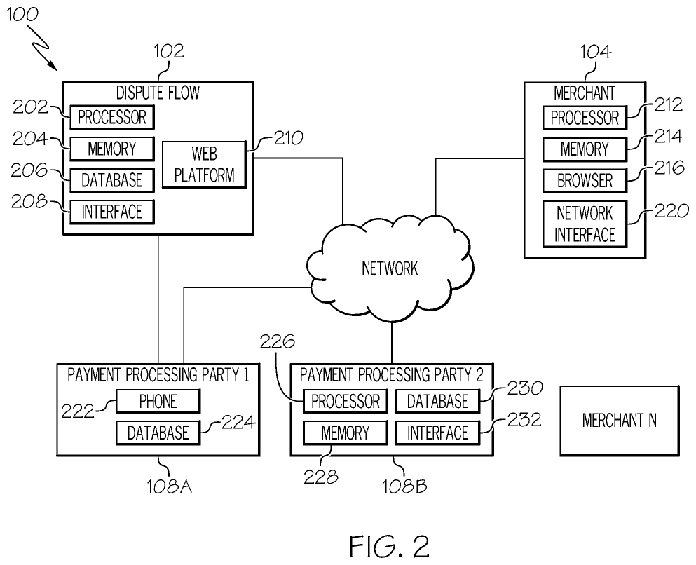

FIG. 2 illustrates the hardware components of a dispute processing system 100 in a non-limiting embodiment of the present disclosure. The DisputeFlow system 102 may include a processor 202, memory 204, a database 206, interfaces 208 (e.g., communication interfaces, telephone interface, fax interface, network interface), and a web platform 210. In some embodiments, a subset of the hardware identified may be present in the system. The merchant system 104 may include a processor 212, memory 214, a browser 216, and a network interface 220. The first payment processing party 108A may include a telephone interface 222 and a database 224. Since the payment processing parties 108 may take any number of forms and may communicate using various methods, the underlying systems used by the payment processing parties may vary significantly. For example, the second payment processing party 108B may include a processor 226, memory 228, a database 230, and an interface 232.

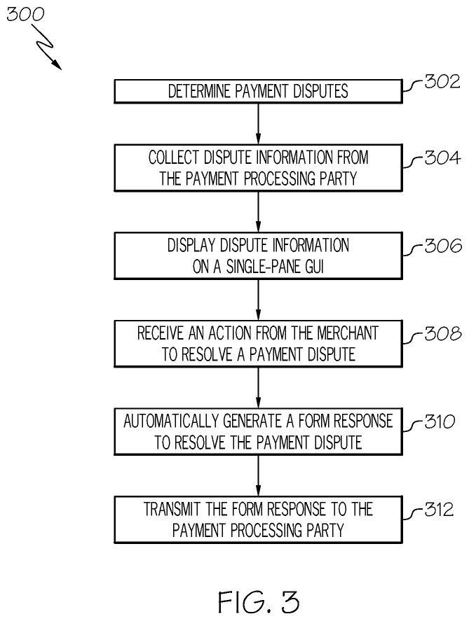

FIG. 3 illustrates a flowchart of the method of displaying and responding to payment disputes in a non-limiting embodiment of the present disclosure. The payment dispute collection, display, and response flow 300 begins with step 302, where DisputeFlow 102 determines the payment disputes associated with the merchant 104. In order to determine the payment disputes associated with the merchant 104, DisputeFlow 102 may first obtain login information from the merchant for each payment processing entity 106 the merchant 104 wants to monitor using DisputeFlow 102. In some embodiments, the merchant 104 may decide to only provide login information sufficient to retrieve information about a particular payment dispute. In other embodiments, the merchant 104 may provide login information sufficient to retrieve all payment disputes for each of a plurality of payment processing entities. The login information provided by the merchant 104 to DisputeFlow 102 may be limited in scope to only payment dispute information. The merchant 104 may not provide access to all order or transaction information, but rather only to particular information necessary for processing and responding to payment disputes.

In step 304, DisputeFlow 102 collects the payment dispute information from the payment processing party 108. In embodiments where the merchant 104 has provided login information for multiple payment processing parties, DisputeFlow 102 will collect the merchant's payment dispute information from each of the payment processing parties. The information collected from the payment processing parties may vary widely based on the information available, but may include the case number, merchant account identification number, disputed amount, currency type, date of dispute, dispute reason code, and credit card information. Credit card information collected in this manner is typically limited to last 4 digits, but in some cases first 6 digits may be provided. Alone or in combination, these numbers are typically not unique enough to confidently match if the organization is large (in large organizations, there can be dozens, hundreds or thousands of 500 unique orders that all have the same first 6 digits, or last 4 digits of a credit card.) Moreover, the transaction date given by the payment processor does not always match the transaction date recorded by the merchant—this can happen due to differences in time zones or when the bank settles the transaction in batches or otherwise cause the transaction to be delayed from when the merchant recorded it. Further, the disputed amount does not always match the transaction amount which makes it very hard to match—this can happen when there is a difference in currency (these types of dispute reports from a payment processor don't typically identify the type of currency), or this can happen for example when someone buys two products and only disputes one (the transaction amount could be $100 while the dispute amount is $50). For at least these reasons, it often requires a sophisticated set of algorithms in order to utilize each of these data points in combination to accurately match disputes to transactions (see e.g., see e.g., U.S. patent application Ser. No. 14/292,496, entitled Transaction Matching and filed May 30, 2014).

The method of communication between DisputeFlow 102 and the plurality of payment processing parties may vary widely. For example, some payment processing parties 108 have simple software APIs available to programmatically submit login information and retrieve payment dispute information. Other payment processing parties 108 may have different communication protocols, such as making a telephone call to retrieve payment dispute information, sending and receiving faxes or mail to submit login information and collect payment dispute information, or communicating with a payment processing party's server using a file-transfer protocol (i.e., FTP). In other embodiments, the payment processing party 108 may not have any method for users to programmatically retrieve payment dispute information, and in these cases DisputeFlow 102 may use scraping software to load a website and programmatically extract relevant information from the text or data displayed in the browser (see e.g., U.S. Pat. No. 9,600,845 B2 issued Mar. 21, 2017 which is hereby incorporated by reference).

In some embodiments, DisputeFlow 102 will store the collected payment dispute information. For example, DisputeFlow 102 may store the collected payment information in a database, flat file, or other storage mechanism. In some embodiments, DisputeFlow 102 may convert the collected payment dispute information into an internal common format. A benefit of converting the collected payment dispute information into a common format may be that the converted information is easier to process and display to the user.

After collecting the payment dispute information, in step 306, DisputeFlow 102 may display the payment dispute information to the merchant in a single-pane graphical user interface (“GUI”). This allows multiple disputed transactions that may be unrelated (different merchants, different customers, different products, and/or different physical store locations, etc.) to be displayed together on a single GUI. DisputeFlow's GUI may combine the payment dispute information from a plurality of payment processing parties into a single-pane view for all pending payment disputes. This single-pane view may provide the benefit of allowing the merchant to see and process all the pending payment disputes at once. DisputeFlow's GUI also provides the ability to sort the pending payment disputes by any of the fields provided, allowing the merchant the flexibility to determine which payment disputes are most important to view.

In some embodiments, the DisputeFlow GUI may have multiple tabs to organize the payment disputes by phase. For example, in some embodiments, the DisputeFlow GUI may have a “New,” “Pending,” and “Completed” category tabs to organize the payment disputes. In these embodiments, the “New” tab may display those payment disputes that have been collected from the payment processing party but have not yet been addressed by the merchant. In these embodiments, the “Pending” tab may display those payment disputes that the merchant has responded to, but that have not yet been resolved by the payment processing party. In these embodiments, the “completed” tab may display those payment disputes that have been responded to by the merchant and have been resolved by the payment processing party.

In some embodiments, the individual rows in each tab of the DisputeFlow GUI may be color-coded. In some embodiments, the color-coding system may correspond to the urgency in responding to a new payment dispute. For example, some payment processing parties require a response to a payment dispute within 30 days. In some embodiments, the color-coding system may show new payment disputes pending for less than 15 days in green, those pending for 15-25 days in yellow, and those pending for 25 days or more in red. In some embodiments, the DisputeFlow GUI may be sorted to display the new payment disputes in order of urgency (e.g., red, yellow, then green). In some embodiments, the color-coding system may vary by payment processing party. In other embodiments, the color-coding system may be customized by the merchant based on a plurality of information. For example, higher value disputes may be prioritized over lower value disputes.

The DisputeFlow GUI also provides the merchant the ability to select an action to take regarding a payment dispute. For example, in some embodiments, payment disputes displayed on the “New” tab may allow the merchant to select the following actions: “Create Dispute Response” or “Do Not Fight Dispute.” Depending on the selection made by the merchant, DisputeFlow may take a plurality of different actions to effectuate that action.

In step 308, DisputeFlow 102 may receive an action from the merchant 104 to resolve or respond to a particular payment dispute. For example, in some embodiments, the merchant 104 may select the “Do Not Fight Dispute” action which may cause DisputeFlow to automatically create an acceptance letter for the payment processing party associated with the selected payment dispute. In some embodiments, the merchant 104 may select the “Create Dispute Response” action which may cause DisputeFlow 102 to automatically create a response package for the payment processing party associated with the selected payment dispute.

In step 310, DisputeFlow 102 automatically generates a form response to resolve the payment dispute in response to receiving an action from the merchant. Generally, this form response may take one of two forms: an acceptance letter or a response package. The acceptance letter may be generated in response to the merchant choosing to not fight the dispute. The acceptance letter may be generated based on the payment processing party requirements associated with the payment dispute. The acceptance letter may be generated based on the merchant information already provided to DisputeFlow 102, the communication protocol of the payment processing party, and the payment processing party's acceptance letter requirements. In some embodiments, the payment processing party's communication protocols, requirements, and other party-specific information may be stored by DisputeFlow 102 when the payment processing party is added to the list of payment processing parties. In some embodiments, the payment processing party information may be specific to a particular merchant.

A response package may be automatically generated by DisputeFlow 102 in response to the merchant choosing to create a dispute response. DisputeFlow 102 may automatically generate a form response package based on available merchant information and the available dispute information. The response package typically includes a cover page, transaction details, dispute details, the order record, transaction terms and conditions, and other specific evidence of the transaction. In some embodiments, the merchant has the ability to edit some or all portions of the response package before submitting the response package to the payment processing party. For example, in some embodiments, the merchant may be prevented from editing the dispute case number, the merchant account ID, and the basic dispute information received from the payment processor since some or all of these may be required to be included the response to the dispute. The merchant may also be able to add evidence specific to the transaction and dispute to the response package. For example, the merchant may attach a proof of delivery document to the response package to support rejecting the payment dispute. Other evidence used by the merchant may include the company description, product description, transaction information, order information, order history, delivery confirmation, proof of usage, service contracts, terms and conditions, and website images. In some embodiments, DisputeFlow 102 may store the prepared response package, or portions of the prepared response package, as a template for the merchant for future payment dispute responses. In some embodiments, DisputeFlow 102 may give the merchant the option to save the response package, or portions of the response package, as a template.

In some embodiments, the response package may be automatically generated using analytics information obtained from the merchant's payment dispute history available within DisputeFlow. For example, based on the reason code provided for the payment dispute, DisputeFlow may automatically generate different forms or provide different types of information to respond to the payment dispute based on the effectiveness of those forms or information in past payment disputes by the merchant. For example, if it is a fraudulent reason code the CVV and AVS match information may be automatically provided prominently on the first page. Or in an alternative embodiment, if the customer was refunded this fact may automatically be prominently explained/described on the first page.

In step 312, after DisputeFlow 102 has automatically generated a form response (e.g., acceptance letter, response package) and the merchant has made any optional edits, DisputeFlow 102 transmits the form response to the payment processing party. The form response may be transmitted using any communication protocol used by the payment processing party. In some embodiments, the communication protocols used by each payment processing party is stored by DisputeFlow 102. This stored payment processing party information may be used to determine the method for transmitting the form response to the payment processing party.

DisputeFlow 102, after transmitting the form response, may move the payment dispute from the “New” tab to the “Pending” or “Complete” tab. The “Pending” tab displays the payment disputes have been responded to by the merchant, and are pending resolution by the payment processing party. The “Complete” tab displays the payment disputes that have been responded to with an acceptance letter (i.e., accepting the payment dispute resolution) and those that have been resolved by the payment processing party.

After sending the response package to the payment processing party, DisputeFlow 102 periodically monitors the pending payment disputes. DisputeFlow 102 may periodically (e.g., every minute, every hour, every eight hours, every day, every week) connect to the payment processing entity associated with the pending payment dispute and retrieve updated information regarding the payment dispute. In some cases, the payment processing party 108 may provide updates directly to DisputeFlow 102 whenever the payment dispute is updated, and thus do not need to be periodically polled. DisputeFlow 102 may provide a notification to the merchant when the status of a payment dispute changes. Once a pending payment dispute is updated as resolved by the payment processing party, the payment dispute is moved to the “Complete” tab in the DisputeFlow 102 GUI.

DisputeFlow 102 may provide notifications to the merchant regarding the status of payment disputes. These notifications may be sent to the merchant in various formats, for example, by email, browser notification, text message, telephone, API, or other notification formats. The notification may be activated by the merchant in response to any information available to the merchant's DisputeFlow account. For example, if a new payment dispute has five days remaining before the payment processing party automatically resolves the dispute against the merchant, the merchant may be notified via email and a browser notification when the merchant is logged into DisputeFlow. The notifications may also include thresholds or other complex logic to trigger notifications. For example, if more than fifty percent of the completed payment disputes indicate that the merchant lost the dispute, an email may be sent to the merchant including a report of information or analytics about the payment disputes in question.

The teachings of the present disclosure may be applied to a plurality of payment disputes associated with a plurality of processing parties and applicable to a single merchant. In another embodiment, the teachings may be applied to a plurality of payment disputes associated with a plurality of merchants and applicable to a plurality of merchants. A person of ordinary skill in the art will understand that the teachings of the present invention may be applied in embodiments that include any number of payment disputes applicable to any number of merchants and/or any number of payment processing third parties. Each payment processing party of the present disclosure is a unique, independent third party with no corporate relationship or legal relationship (other than potentially contractual) with the other payment processing parties and/or merchants. Each merchant of the present disclosure is a unique, independent third party with no corporate relationship or legal relationship (other than potentially contractual) with the other merchants and/or payment processing parties.

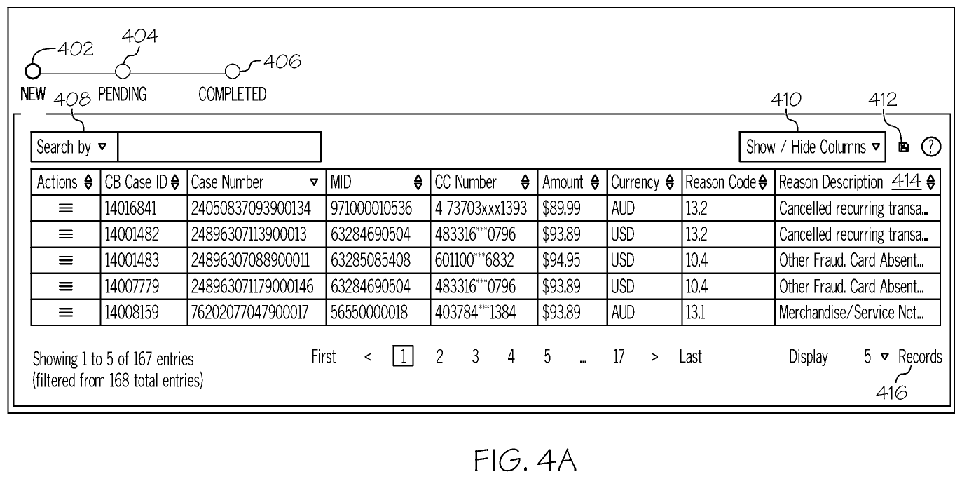

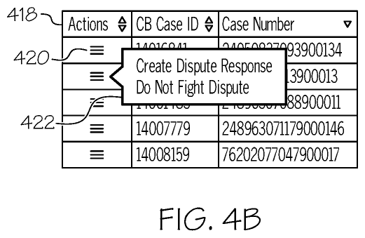

FIG. 4A illustrates the home screen of a graphical user interface 400 in a non-limiting embodiment of the present disclosure. The figure shows the GUI for the payment disputes displayed on the “New” tab 402. The merchant may also select to view the “Pending” tab 404 or the “Completed” tab 406. The “New” tab 402 may display the payment disputes that the merchant has not yet responded to.

The home screen of the graphical user interface 400 may include several elements to display and organize the payment disputes. For example, the GUI 400 may include a search field 408 which may allow the merchant to search the payment disputes. The search field 408 may search a keyword across the entire table, or search by a particular column or payment dispute attribute. The merchant may choose to show or hide various columns or payment dispute attributes using a selection box 410. The merchant also may have the ability to save the displayed payment disputes using the “Save” button 412. The “Save” button may allow the merchant to save the displayed payment dispute information, all the payment disputes, or any subset of information available to DisputeFlow 102. The “Save” button may also allow the merchant to choose which columns or payment dispute attributes to save for each payment dispute.

Information about the payment disputes may be displayed in the payment dispute table 414. The table includes headers that describe the information collected about the payment disputes. These headers may be different for each tab (e.g., “New,” “Pending,” “Completed) depending on the type of information that is relevant to that payment dispute stage. On the “New” tab 402, for example, the payment dispute attributes may include the Chargeback (“CB”) Case ID, Case Number, Merchant/Domain ID (“MID”), Credit Card Number, Chargeback/Disputed Amount, Currency of transaction, Reason Code, and Reason Description. Other payment dispute attributes may be displayed by DisputeFlow 102 depending on the information available to the merchant and the payment dispute attributes selected for display by the merchant. Each of the display columns may be sortable by the merchant to easily display relevant information. The rows of the table may be color coded according to a predetermined classification system (e.g., by response deadline, by chargeback amount) or by any classification system chosen by the merchant.

The merchant may also select how many records to display per screen using the “Display Records” dropdown box 416. In some embodiments, the “Display Records” dropdown box 416 may be dynamically chosen by DisputeFlow 102 based on the number of records available to the merchant on the chosen tab. In other embodiments, the “Display Records” dropdown box 416 may be chosen by the merchant. DisputeFlow 102 may also save the “Display Records” dropdown box 416 choice and always display the chosen number of records for the given merchant.

In addition to the payment dispute attributes displayed in the payment dispute table 414, the payment dispute table may include an “Actions” column 418 as depicted in FIGS. 4A and 4B. After selecting the action icon 420, DisputeFlow 102 may display the action options 422 to the merchant. The action options 422 may be displayed to the merchant using a visual element (e.g., popup, balloon, new screen, dropdown menu, selection box). The displayed action options 422 may vary depending on the tab being displayed. In the case of the “New” tab 402, the merchant may have the action options 422 of selecting to “Create a Dispute Response” or “Do Not Fight Dispute.” Depending on the action chosen by the merchant, DisputeFlow 102 may proceed according to the response flow 300.

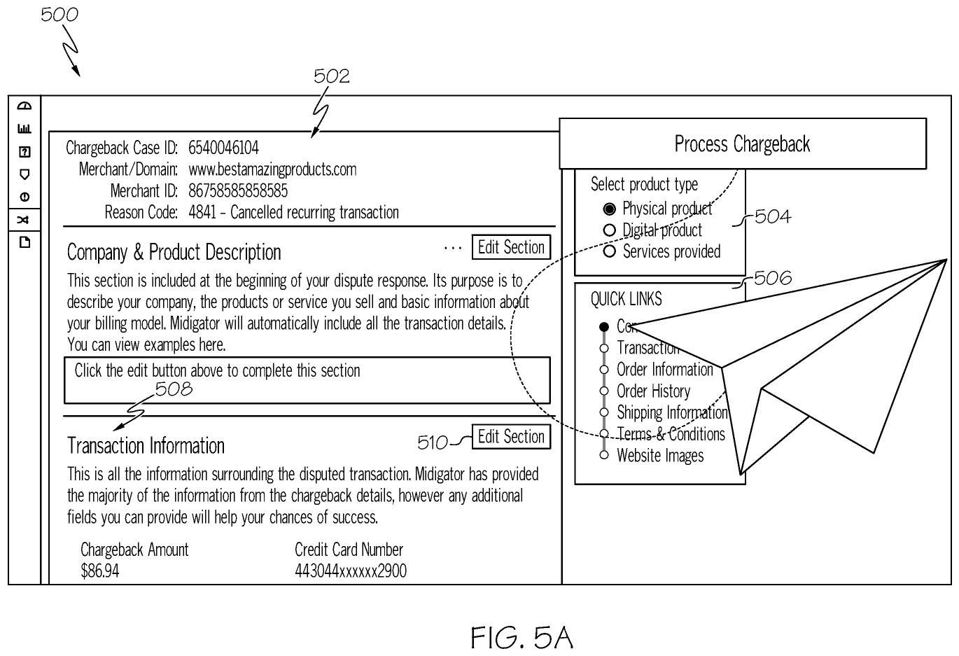

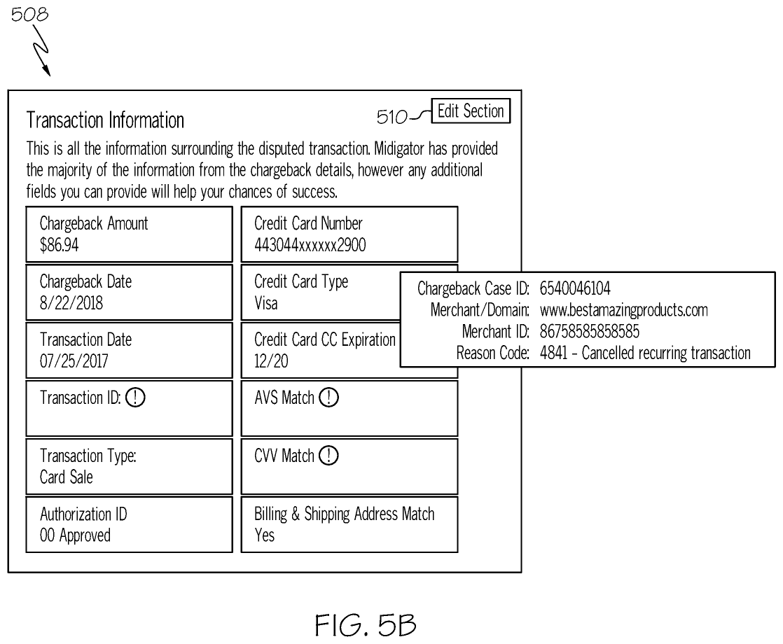

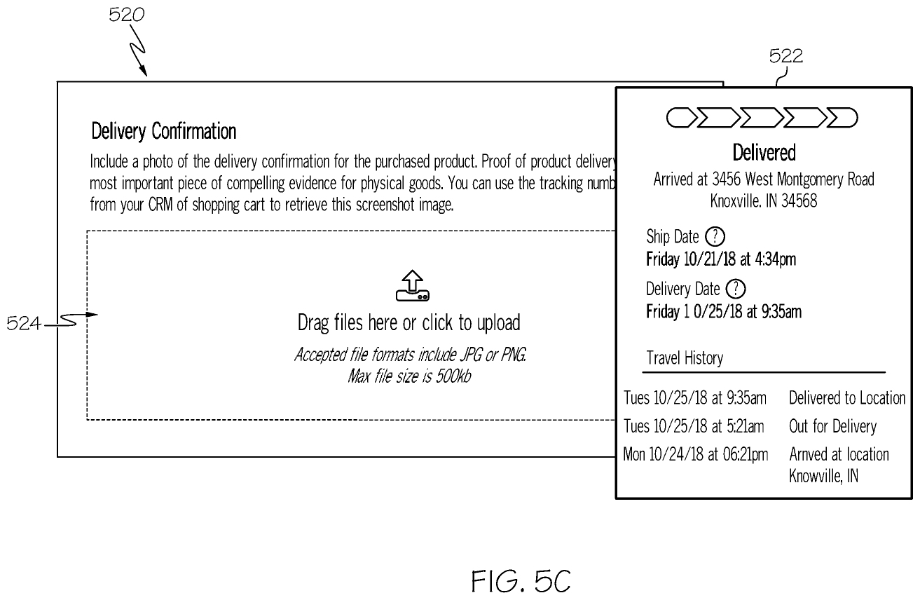

FIG. 5A illustrates a customizable response package 500 in a non-limiting embodiment of the present disclosure. The customizable response package 500 may be automatically generated by DisputeFlow 102 in response to a merchant selecting the action to fight the payment dispute. In some embodiments, the response package may not be customizable and is automatically generated based on the merchant's preferences or previous responses. In other embodiments, the customizable response package 500 may be pre-populated according to the merchant's preferences, previous responses by the merchant, information gathered about the dispute by DisputeFlow 102, or other information available to DisputeFlow 102.

DisputeFlow 102 may display the customizable response package 500 within the DisputeFlow GUI on the “Process Chargeback” screen 502. The screen 502 may display different elements based on the merchant's preferences. For example, the “Select product type” radio selection box 504 may provide the merchant the option to select the type of product as a “Physical product,” “Digital product,” or “Service provided.” Based on the selection by the merchant, the “Process Chargeback” screen 502 may be changed or edited to show the sections relevant to that type of product. The sections included in the customizable response package 500 may be displayed in the “Quick Links” section 506 of the “Process Chargeback” screen 502. The “Quick Links” section 506 may include sections for the company and product description, transaction information, order information, order history, shipping information, terms and conditions, and website images. Each of the sections may be editable. Each of the sections may also allow the merchant to attach additional information or files. For example, the “Transaction Information” section 508 may have an “Edit Section” button 510 that allows the merchant to add additional transaction information not provided by the payment processing party or transaction information not available to DisputeFlow 102.

FIG. 5B illustrates a transaction information section 508 of a customizable response package in a non-limiting embodiment of the present disclosure. The “Transaction Information” section 508 may be automatically populated with the transaction information available to DisputeFlow 102. This information may include the chargeback amount, chargeback date, transaction date, transaction ID, transaction type, authorization ID, credit card number, credit card type, credit card expiration, address verification system (“AVS”) match, card verification value (“CVV”) match, billing and shipping address match, chargeback case ID, merchant/domain, merchant/domain ID, reason code, and reason description. The merchant may choose to edit, change, or add additional relevant information. The merchant may also be given the option to attach any files that might help in fighting the payment dispute.

FIG. 5C illustrates a delivery confirmation section 520 of a customizable response package in a non-limiting embodiment of the present disclosure. In some embodiments, the delivery confirmation section 520 of the customizable response package 500 may be located in the “Shipping Information” section. The delivery confirmation section 520 may include information already available or gathered by DisputeFlow 102, as depicted by 522. If the delivery confirmation information is not available to DisputeFlow 102, the merchant may decide to add a file or image of the delivery confirmation in the upload section 524. Once a file is uploaded, the file may be formatted and added to the customized response package 500.

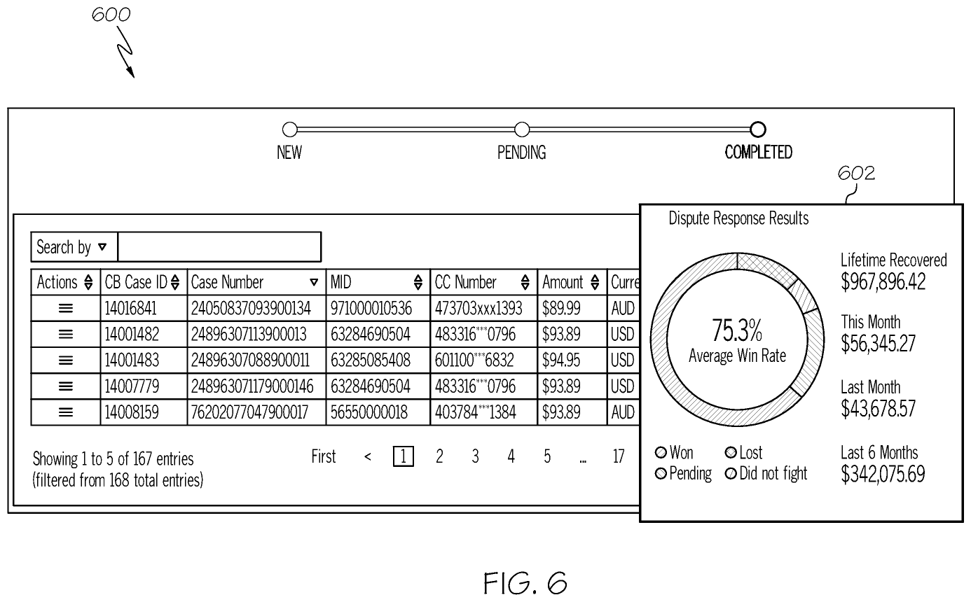

FIG. 6 illustrates analytics information displayed on a graphical user interface in a non-limiting embodiment of the present disclosure. The “Completed” screen 600 may include a table displaying similar information as presented on the “New” tab in FIG. 4A. Each tab may also have an option to display analytics information about the payment disputes. The analytics information may display information on payment disputes on that screen, filtered payment disputes, or all the payment disputes. The analytics information may be collected by DisputeFlow 102 as the payment dispute information is updated. Thus, in some embodiments, the analytics information may reflect the real-time status of the payment disputes being tracked by DisputeFlow 102.

For example, the “Dispute Response Results” analytics screen 602 may display information on the amount of money recovered by the merchant over the lifetime of using DisputeFlow 102, the amount of money recovered by the merchant so far in the month, the amount of money recovered by the merchant last month, and the amount of money recovered by the merchant in the past six months. The “Dispute Response Results” analytics screen 602 may also display a pie chart depicting the average payment dispute win rate, the percentage of payment disputes won, the percentage of payment disputes lost, the percentage of payment disputes pending, the percentage of payment disputes not disputed. While the “Dispute Response Results” analytics screen 602 is depicted in FIG. 6, any number of different analytics screens may be displayed in different embodiments of DisputeFlow 102 depending on the type of information requested by the merchant. In some embodiments, DisputeFlow 102 may process and store commonly used analytics information rather than determining the analytics information at the time the analytics information is requested. In other embodiments, DisputeFlow 102 may process the analytics information in real-time when requested by the merchant.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
determining, from a plurality of payment processing parties, a plurality of payment disputes associated with a merchant;
the plurality of payment processing entities including a first payment processing party and a second payment processing party;
the plurality of payment disputes including a first payment dispute associated with the first payment processing party and a second payment dispute associated with the second payment processing party.
collecting, from the first payment processing party, first dispute information associated with the first payment dispute and collecting, from the second payment processing party, second dispute information associated with the second payment dispute;
displaying the first dispute information and the second dispute information together on a graphical user interface;
in response to displaying the first dispute information and second dispute information, receiving, from the merchant, an action to resolve the first payment dispute;
automatically generating a form response to the first payment dispute in response to receiving the action to resolve the first payment dispute; and
transmitting, to the first payment processing party, the form response to the first payment dispute in response to automatically generating the form response to the first payment dispute.

2. The method of claim 1, further comprising:
collecting, from the first payment processing party, dispute resolution information related to the first payment dispute;
displaying the dispute resolution information related to the first payment dispute;
analyzing the dispute resolution information related to the first payment dispute.

3. The method of claim 2, further comprising:
in response to collecting, from the first payment processing party, dispute resolution information related to the first payment dispute, updating status information regarding the first payment dispute in a memory.

4. The method of claim 2, wherein analyzing the dispute resolution information related to the first payment dispute further comprises:
determining characteristics of the first payment dispute that were successful in resolving the first payment dispute;
determining characteristics of the first payment dispute that were unsuccessful in resolving the first payment dispute;
storing information regarding characteristics of the first dispute that were successful in resolving the first payment dispute and characteristics that were unsuccessful in resolving the first payment dispute; and
analyzing the stored information to identify procedural changes to improve success rates in resolving future payment disputes.

5. The method of claim 1, further comprising:
wherein receiving, from the merchant, an action to resolve the first payment dispute further comprises:
receiving, from the merchant, an action to contest the payment dispute;
receiving, from the merchant, information regarding the transaction;
wherein automatically generating a form response to the first payment dispute further comprises:
automatically generating a customizable response package; and
receiving, from the merchant, modifications to the customizable response package.

6. The method of claim 5, wherein automatically generating a customizable response package comprises automatically generating a customizable response package based upon predefined and stored preferences of the merchant.

7. The method of claim 5, wherein automatically generating a customizable response package comprises automatically generating a customizable response package based upon predefined and stored product type and the information regarding the transaction.

8. A computer configured to access a storage device, the computer comprising:
a processor; and
a non-transitory, computer-readable storage medium storing computer-readable instructions that when executed by the processor cause the computer to perform:
determining, from a plurality of payment processing parties, a plurality of payment disputes associated with a merchant;
the plurality of payment processing entities including a first payment processing party and a second payment processing party;
the plurality of payment disputes including a first payment dispute associated with the first payment processing party and a second payment dispute associated with the second payment processing party;
collecting, from the first payment processing party, first dispute information associated with the first payment dispute and collecting, from the second payment processing party, second dispute information associated with the second payment dispute;
displaying the first dispute information and the second dispute information together on a graphical user interface;
in response to displaying the first dispute information and second dispute information, receiving, from the merchant, an action to resolve the first payment dispute;
automatically generating a form response to the first payment dispute in response to receiving the action to resolve the first payment dispute; and
transmitting, to the first payment processing party, the form response to the first payment dispute in response to automatically generating the form response to the first payment dispute.

9. The computer of claim 8, wherein the computer-readable instructions further cause the computer to perform:
collecting, from the first payment processing party, dispute resolution information related to the first payment dispute;
displaying the dispute resolution information related to the first payment dispute; and
analyzing the dispute resolution information related to the first payment dispute.

10. The computer of claim 9, wherein the computer-readable instructions further cause the computer to perform:
in response to collecting, from the first payment processing party, dispute resolution information related to the first payment dispute, sending a notification to the merchant regarding the dispute resolution information related to the first payment dispute.

11. The computer of claim 9, wherein analyzing the dispute resolution information related to the first payment dispute further comprises:
determining characteristics of the first payment dispute that were successful in resolving the first payment dispute;
determining characteristics of the first payment dispute that were unsuccessful in resolving the first payment dispute;
combining the determined characteristics of the first payment dispute with determined characteristics of the plurality of payment disputes associated with the merchant;
displaying the determined characteristics of successful and unsuccessful payment disputes.

12. The computer of claim 8, further comprising:
wherein receiving, from the merchant, an action to resolve the first payment dispute further comprises:
receiving, from the merchant, an action to contest the payment dispute;
receiving, from the merchant, information regarding the product type;
wherein automatically generating a form response to the first payment dispute further comprises:
automatically generating a customizable response package; and
receiving, from the merchant, modifications to the customizable response package.

13. The computer of claim 12, wherein automatically generating a customizable response package comprises automatically generating a customizable response package based upon predefined and stored preferences of the merchant.

14. The computer of claim 12, wherein automatically generating a customizable response package comprises automatically generating a customizable response package based upon predefined and stored product type information.

15. A computer program product comprising:
a computer-readable storage medium having computer-readable program code embodied therewith, the computer-readable program code comprising:
computer-readable program code configured to determine, from a plurality of payment processing parties, a plurality of payment disputes associated with a merchant;
the plurality of payment processing entities including a first payment processing party and a second payment processing party;
the plurality of payment disputes including a first payment dispute associated with the first payment processing party and a second payment dispute associated with the second payment processing party;
computer-readable program code configured to collect, from the first payment processing party, first dispute information associated with the first payment dispute and collecting, from the second payment processing party, second dispute information associated with the second payment dispute;
computer-readable program code configured to display the first dispute information and the second dispute information together on a graphical user interface;
computer-readable program code configured to, in response to displaying the first dispute information and second dispute information, receive, from the merchant, an action to resolve the first payment dispute;
computer-readable program code configured to automatically generate a form response to the first payment dispute in response to receiving the action to resolve the first payment dispute; and
computer-readable program code configured to transmit, to the first payment processing party, the form response to the first payment dispute in response to automatically generating the form response to the first payment dispute.

16. The computer program product of claim 15, the computer readable program code further comprising:
computer-readable program code configured to collect, from the first payment processing party, dispute resolution information related to the first payment dispute;
computer-readable program code configured to display the dispute resolution information related to the first payment dispute; and
computer-readable program code configured to analyze the dispute resolution information related to the first payment dispute.

17. The computer program product of claim 16, the computer readable program code further comprising:
computer-readable program code configured to, in response to collecting, from the first payment processing party, dispute resolution information related to the first payment dispute, send a notification to the merchant regarding the dispute resolution information related to the first payment dispute.

18. The computer program product of claim 16, the computer readable program code further comprising:
computer-readable program code configured to determine characteristics of the first payment dispute that were successful in resolving the first payment dispute;
computer-readable program code configured to determine characteristics of the first payment dispute that were unsuccessful in resolving the first payment dispute;
computer-readable program code configured to combine the determined characteristics of the first payment dispute with determined characteristics of the plurality of payment disputes associated with the merchant; and
computer-readable program code configured to display the determined characteristics of successful and unsuccessful payment disputes.

19. The computer program product of claim 15, the computer readable program code further comprising:
computer-readable program code configured to receive, from the merchant, an action to contest the payment dispute;
computer-readable program code configured to receive, from the merchant, information regarding the product type;
computer-readable program code configured to automatically generate a customizable response package; and
computer-readable program code configured to receive, from the merchant, modifications to the customizable response package.

20. The computer program product of claim 19, the computer readable program code further comprising:
computer-readable program code configured to automatically generate a customizable response package based upon predefined and stored preferences of the merchant.
